(19) United States
(12) Patent Application Publication
(10) Pub. No.: US 2006/0244564 A1
(43) Pub. Date: Nov. 2, 2006

(54) Secured entertainment seating

(76) Inventor: Josh Dunning Madsen, Tucson, AZ (US)

Correspondence Address: Josh Dunning Madsen, 3035 N Deer Track, Tucson, AZ, 85749, US

(21) Appl. No.: 11/116,151

(22) Filed: Apr. 28, 2005

(51) Int. Cl. G05B 19/00; A47C 1/02

(52) U.S. Cl. 340/5.6; 297/344.22

(57) ABSTRACT

The invention is a secured entertainment seating system. Typically the secured seating at theaters, sporting arenas, concert halls, classrooms and convention centers consists of rows of seats fixed to the floor. These seats typically are constructed with seat cushions that automatically fold upward and lock when not in use. The lock will disengage when the correct keycard has been inserted into the keycard reader, which is integrated into the bottom-folding cushion. Accordingly, patrons observing their seating assignments will not have to hassle with claiming their rightful seats from someone who is not in accordance with their seating assignment, which causes disruption and unrest to all those nearby. Additionally venues can be assured that all those in attendance have paid admission to an event, which will prevent annual losses in ticket sales due to people sneaking into events. Finally parents can take comfort in knowing that if they drop their children off at the theaters inappropriate movies will not be accessible to anyone underage.

### TECHNICAL FIELD

The present invention relates to the entertainment industry, and more particularly the invention relates to seating at events that require paid admission.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C section 102 or 35 U.S.C section 103. Thus, nothing stated in the Statement of a Problem Addressed by This Invention is to be construed as prior art.

Discussion

Many entertainment venues are faced with the ongoing problem of theft and wrongful seating at events. For example, it is common for many theaters to hire either in-house personnel or an outside security company to monitor exits so that people do not sneak into these venues to avoid paying admission. This security often acts as only a deterrent to some, and still does not prevent theft from occurring once people have entered a facility even if they have paid full admission. For example, some people may purchase one ticket then rendezvous with accomplices at any given door and let those in who have not paid admission. Furthermore, there is no safeguard against people viewing more than one movie on one or no ticket during the course of a single visit to the theater. Cellular technology has made this type of behavior even easier to execute by allowing people to look up movie times on the internet via a cellular phone in the theater. Thieves can now remain in constant communication with those outside a secured area, which further compromises the security of a premises. The entertainment industry would benefit from a system that would restrict access to the seating within a given event, where only those with a validated keycard could access a particular seat or a group of seats within a location consistent with the access information embedded within a keycard.

This type of secured seating system would be beneficial to not only the venue owners, but also to the entertainment industry and the patrons. Aside from decreasing the amount of revenue lost to theft, this system would also decrease the amount spent on security overhead. Additionally, this secured seating system would provide an opportunity to collect industry data that may be beneficial in creating better entertainment environments and lead to more effective marketing strategies made on behalf of the entertainment industry.

### SELECTED OVERVIEW OF SELECTED EMBODIMENTS

The present invention achieves technical advantages as secured seating systems. Typically theater and arena seating consist of rows of cushioned chairs or seats with lower seating cushions that fold upward to aid in passage and reduce space each seat requires. Typically when the seat is unoccupied the bottom cushion automatically retracts into a locked position that is achieved by the actuation of an electronic, mechanical or magnetic lock. The seat will remain locked and thus inaccessible to anyone who does not insert a valid keycard into the keycard receiver, which authenticates the card and thus releases the lock allowing the patron access to the seat.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a Secured Entertainment Seating System

FIG. 2 Provides a block diagram of the Secured Entertainment Seating System; and

FIG. 3 shows an alternative embodiment of a Secured Entertainment Seating System.

### AN EXEMPLARY EMBODIMENT OF A BEST MODE

Interpretation Considerations

When reading this section (AN EXEMPLARY EMBODIMENT OF A BEST MODE, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way. The following exemplary embodiment should not be interpreted as limiting the invention to one embodiment.

Likewise, individual aspects (sometimes called species) of the invention are provided as examples, and accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, welding, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in .sctn.112, paragraph 6 of 35 U.S.C., unless used as “means for -functioning-” or “step for -functioning-” in the Claims section.

Discussion of the Figures

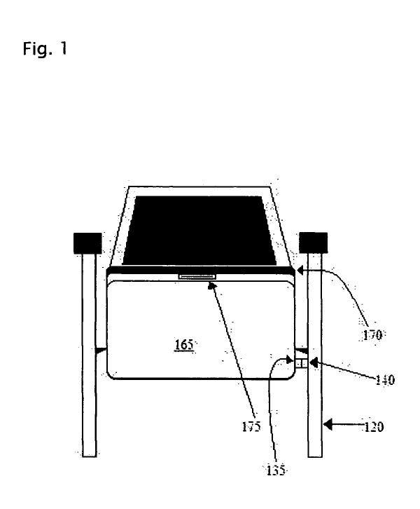

Features and advantages of the invention can be better understood by reviewing FIG. 1, which illustrates a Secured Entertainment Seating System 100 according to the teachings of the invention. The Secured Entertainment Seating System 100 is in the locked position. The locked position is achieved when a seat is vacated and the lower seat cushion 170, lower seat cushion housing 165, and integrated keycard reader 175 swing into the upward position. A UL 1034 burglary resistant electric strike lock 135 is also integrated into the lower seat cushion housing 165. This UL 1034 burglary resistant electric strike lock 135 receives the male locking peg 140 which is securely attached to the left chair frame 120. The integrated keycard reader 175 and UL 1034 burglary resistant electric strike lock 135 are well known in the art of security.

The integrated keycard reader 175 will prevent movement of the lower seat cushion 170 and lower seat cushion housing 165 without insertion of a valid keycard into the integrated keycard reader 175. The integrated keycard reader 175 will act as a switch allowing current to flow into the UL 1034 burglary resistant electric strike lock 135 when a valid keycard has been inserted. Once current is provided to the UL 1034 burglary resistant electric strike lock 135 the lock will disengage and allow a patron to swing the lower seat cushion 170 and lower seat cushion housing 165 down so that it may be sat on. The UL 1034 burglary resistant electric strike lock 135 and the male locking peg 140 are a specific example of a locking system. In a preferred embodiment other types of electronically operated locking systems may be used. Likewise in a preferred embodiment other types of electronic or digital validation input devices may be used in place of the integrated keycard reader 174, as long as the device functions as a switch to disengage the preferred electronically operated lock.

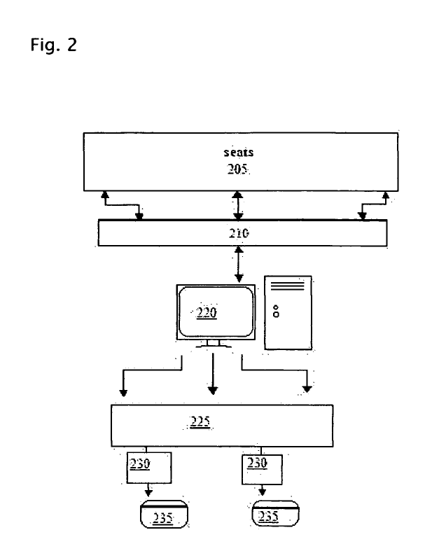

FIG. 2 provides a block diagram of the Secured Entertainment Seating System 200. In a preferred embodiment the Secured Entertainment Seating System 200 will generally be comprised of seating with integrated locking systems 205, each one assigned an address on a central security network 220 that is communicated via a routing device 210. In the preferred embodiment information concerning available seating will be relayed from the central security network 220 to the admission point of sale terminals 225. Likewise the routing device 210 will also be able to communicate security access information from the central security network 220 to addresses within the seating with integrated locking systems 205. Bilateral communication between seating addresses and the central security network will allow access information to be reset after a given time interval has elapsed or on demand of the system administrator. Attached to the admission point of sale terminals 225 will be encoding devices 230, which encode access information, in the preferred embodiment, onto reprogrammable keycards 235.

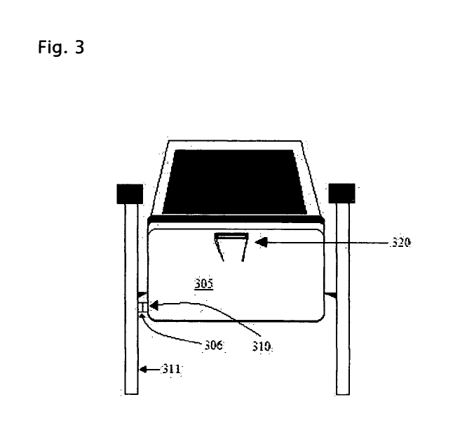

Of course, there are many variations to the invention, which will be readily apparent to those of ordinary skill in the art, and these are incorporated into the invention without departing from the scope of the claims. For example, FIG. 3 shows an alternative embodiment of secured entertainment seating 300. The secured entertainment seating 300 has a locking mechanism 310 built into the right side of the lower seat cushion housing 305, which clasps onto its male counterpart 306 on the right chair frame 311. Alternatively the keycard receiver 320 is flush mounted into the bottom of the lower seat cushion housing 305. Of, course it should be understood that although the discussion herein describes a locking mechanism 310, and locking mechanism male counterpart 306 on the right side of the seat these components can appear on any other portion of the secured entertainment seating so as to obtain the same locking action. Likewise the keycard receiver 320 that described herein may be replaced with any other electronic access device that serves the same electronic switching purpose. It should also be understood the keycard receiver 320 may also be located on any other portion of the secured entertainment seating 300 so that it is obvious and accessible to any patron, as the invention is limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A secured entertainment seating, comprising: a theater type seat having a folding lower seat cushion; and a locking mechanism coupled to an electronic access device.

2. The secured entertainment seating of claim 1 wherein the locking mechanism is integrated within the folding lower seat cushion, and actuates with its locking mechanism counterpart that is fixed to the seating framework.

3. The secured entertainment seating of claim 1 wherein the electronic access device allows a patron with the proper access key to release the lower seat cushion from its upright and locked position.

4. The secured entertainment seating of claim 1 wherein the security access device is adapted to send and receive data.

5. The secured entertainment seating of claim 1 further comprising a power source coupled to the security access device.

6. The secured entertainment seating of claim 1 further comprising an LED, which dispenses light onto the region of the security access device.

7. The secured entertainment seating of claim 4 wherein in the electronic access device allows facility management to remotely unlock seating.

8. The secured entertainment seating of claim 4 wherein the establishment can check the status of a particular seat from a remote location.

9. The secured entertainment seating of claim 4 wherein the establishment can collect statistical data on a particular seating location or group of seats.

10. The secured entertainment seating of claim 1 further comprising a tamper resistant alarm.

11. The secured entertainment seating of claim 1 wherein the security access device is located within the seating frame.

12. The secured entertainment seating of claim 1 wherein the security access device is located within the seat's cushioned backrest.

13. The secured entertainment seating of claim 1 wherein the security access device is located within the seat's armrest.

14. The secured entertainment seating of claim 1 wherein the locking mechanism is located within the seat's cushioned backrest.

15. The secured entertainment seating of claim 1 wherein the locking mechanism is located within the seat's framework.

16. The secured entertainment seating of claim 1 wherein the locking mechanism is located within the seat's armrest.
